(19) United States
(12) Patent Application Publication
(10) Pub. No.: US 2014/0170026 A1
(43) Pub. Date: Jun. 19, 2014

(54) DISPENSING APPARATUS, ANALYZER AND METHOD FOR CONTROLLING DISPENSING APPARATUS

(71) Applicant: Sony Corporation, Tokyo (JP)

(72) Inventors: Hatsume Uno, Tokyo (JP); Eriko Matsui, Tokyo (JP); Shinsuke Haga, Tokyo (JP); Teppei Toyoizumi, Tokyo (JP)

(73) Assignee: Sony Corporation, Tokyo (JP)

(21) Appl. No.: 14/099,284

(22) Filed: Dec. 6, 2013

(30) Foreign Application Priority Data
Dec. 18, 2012 (JP) 2012-275971

(51) Int. Cl. G01N 35/10

(52) U.S. Cl. CPC G01N 35/1002
USPC 422/82.05; 222/1; 422/509

(57) ABSTRACT

There is provided a dispensing apparatus including a dispensing unit; and a drive mechanism. The dispensing unit is configured to support a dispensing nozzle, provide the dispensing nozzle with a material to be dispensed, and allow the dispensing nozzle to discharge the material. The drive mechanism is configured to change relative position between a stage and the dispensing nozzle in a second direction and a third direction, where the second direction is a horizontal direction when a first direction is substantially vertical direction, and the third direction is substantially perpendicular to the first direction and to the second direction.

### CROSS REFERENCES TO RELATED APPLICATIONS

The present application claims priority to Japanese Priority Patent Application JP 2012-275971 filed in the Japan Patent Office on Dec. 18, 2012, the entire content of which is hereby incorporated by reference.

### BACKGROUND

The present disclosure relates to a dispensing apparatus which is capable of dispensing a material to a target placed on a stage. The disclosure also relates to an analyzer. The disclosure further relates to a method for controlling a dispensing apparatus.

In biochemical experiments and clinical trials, an operation of pipetting a material such as reagents to a well plate (microplate) or the like is frequently performed. The pipetting (dispensing) may be carried out by an experimenter or by an automatic pipetting machine or the like; and commonly employed is stationary discharging whereby the material is discharged to a fixed point of a target.

After the material is dispensed to the targets, the resulting mixture of each target (such as a liquid contained in the well plate) and the dispensed material may be stirred to be mixed immediately. For example, an analyzer and a sample solution preparing apparatus which accelerate mixing of the target with the dispensed material, by applying agitation such as light vibration and rotation after the material is dispensed into containers, have been disclosed in Japanese Patent Application Laid-Open No. 2007-139463 (hereinafter referred to as Patent Document 1) and Japanese Translation of PCT International Application Publication No. 2008-527973 (hereinafter referred to as Patent Document 2).

### SUMMARY

However, such configurations as described in Patent Documents 1 and 2 which apply agitation to the containers after the stationary discharging to the containers might cause a problem. That is, since the material being dispensed may concentrate at one point in the container, a sample (such as cells) located in this point may be damaged or peeled off. Further, in cases where the affinity of the material of the target and the material being dispensed is small, it would take some time to make them homogeneously mixed even with the application of agitation to the containers; which may affect the experimental system during that time.

Besides, in cases where an experimenter performs agitation simultaneously with the dispensing by using a pipette or the like, since differences in the level of agitation would occur because the skills are different depending on the experimenter, it is difficult to provide uniform experimental conditions. Even in the case when the same experimenter performs pipetting, there is a possibility that the level of agitation would not be the same in all the wells of the well plate.

In view of the above-mentioned circumstances, it is desirable to provide a dispensing apparatus, an analyzer, and a method for controlling a dispensing apparatus which are capable of allowing a material being dispensed to be diffused into a material of a target immediately under uniform conditions.

According to an embodiment of the present disclosure, there is provided a dispensing apparatus including a dispensing unit; and a drive mechanism.

The dispensing unit is configured to support a dispensing nozzle, provide the dispensing nozzle with a material to be dispensed, and allow the dispensing nozzle to discharge the material.

The drive mechanism is configured to change relative position between a stage and the dispensing nozzle in a second direction and a third direction, where the second direction is a horizontal direction when a first direction is substantially vertical direction, and the third direction is substantially perpendicular to the first direction and to the second direction.

With this configuration, in the state where the dispensing nozzle is in contact with a material of a target (such as a liquid in a well plate) placed on the stage, during or after discharging the material through the dispensing nozzle by the dispensing unit, it is able to accelerate the diffusion of the dispensed material into the material of the target by changing the relative position between the stage and the dispensing nozzle. In particular, by changing their relative position horizontally (in the second and the third directions), the effect of the diffusion by the dispensing nozzle can be improved. Further, since the dispensing nozzle is moved by the drive mechanism and not moved by the user, the level of diffusion can be uniformized. Furthermore, as compared to the cases where the material being dispensed is discharged at one point, it is possible to prevent damages to the sample (such as cells) contained in the material of the target.

The dispensing apparatus may further include a control unit configured to control the dispensing unit and the drive mechanism, to change the relative position between the stage and the dispensing nozzle in the second direction and the third direction while allowing the dispensing nozzle to discharge the material.

With such a control by the control unit on the drive mechanism and the dispensing unit, it allows dispensing while changing the relative position between the dispensing nozzle and the stage.

The control unit may be configured to control the drive mechanism so that the dispensing nozzle and the stage are made to move in relative circular motion around the first direction as the rotation axis.

With this configuration, along with accelerating the diffusion of the dispensed material into the material of the target, it is allowed to restrain generation of mechanical vibrations when changing the relative position of the dispensing nozzle with respect to the stage.

The drive mechanism may include a first support shaft which has its axis along the first direction, a second support shaft which has its axis along the second direction, and a third support shaft which has its axis along the third direction. The third support shaft may be configured to drive the second support shaft in the third direction. The second support shaft may be configured to drive the first support shaft in the second direction. The first support shaft may be configured to drive the dispensing unit in the first direction.

With this configuration, the position of the dispensing unit supported by the first support shaft is allowed to be changed in the second and the third directions with respect to the stage, that is, it is made possible to change the relative position between the stage and the dispensing nozzle in the second and the third directions. Since the stage is not driven, it is possible to prevent vibrations from being applied to the stage.

The third support shaft may be configured to drive the second support shaft in the third direction. The second support shaft may be configured to drive the stage in the second direction. The first support shaft may be configured to drive the dispensing unit in the first direction.

With this configuration, the position of the stage is allowed to be changed in the second and the third directions with respect to the dispensing nozzle, that is, it is made possible to change the relative position between the dispensing nozzle and the stage in the second and the third directions. Since the dispensing unit is driven only in the first direction, a dispensing unit-side part of the drive mechanism can be made compact and light in weight.

The third support shaft may be configured to drive the first support shaft in the third direction. The second support shaft may be configured to drive the stage in the second direction. The first support shaft may be configured to drive the dispensing unit in the first direction.

With this configuration, the position of the stage is allowed to be changed in the second direction with respect to the dispensing nozzle, and the position of the dispensing nozzle is allowed to be changed in the third direction with respect to the stage. That is, it is made possible to change the relative position between the dispensing nozzle and the stage in the second and the third directions. Since the second and the third support shafts are respectively disposed at the dispensing unit and the stage, the drive mechanism can be arranged in a balanced manner.

The dispensing apparatus may further include a liquid surface sensing unit which is configured to detect a liquid surface of a liquid contained in a container that is placed on the stage. The control unit may be further configured to regulate the relative position between the stage and the dispensing nozzle in the first direction, based on the result of detection by the liquid surface sensing unit.

This configuration enables the control unit to grasp the situation that the dispensing nozzle is in contact with the liquid surface of the material of the target. Thus it is able to change the relative position between the dispensing nozzle and the stage in the state where the dispensing nozzle is in contact with the material of the target.

According to another embodiment of the present disclosure, there is provided an analyzer including a dispensing unit, a drive mechanism, and an analyzing unit.

The dispensing unit is configured to support a dispensing nozzle, provide the dispensing nozzle with a material to be dispensed, and allow the dispensing nozzle to discharge the material.

The drive mechanism is configured to change relative position between a stage and the dispensing nozzle in a second direction and a third direction, where the second direction is a horizontal direction when a first direction is substantially vertical direction, and the third direction is substantially perpendicular to the first direction and to the second direction.

The analyzing unit is configured to analyze an object of analysis that is placed on the stage.

This configuration allows accelerating the diffusion of the dispensed material into the material of the target, and the level of diffusion can be uniformized. Therefore, it is capable of analyzing the object of analysis under uniform conditions.

The analyzer may further include an illuminator which is configured to illuminate the object of analysis with illumination light. The drive mechanism may include a first support shaft which has its axis along the first direction, a second support shaft which has its axis along the second direction, and a third support shaft which has its axis along the third direction. The third support shaft may be configured to drive the first support shaft and the illuminator in the third direction. The second support shaft may be configured to drive the stage in the second direction. The first support shaft may be configured to drive the dispensing unit in the first direction.

With this configuration, by driving the third support shaft, it can easily switch between the states where the object of analysis is illuminated by the illuminator and where the dispensing unit is dispensing a material to the object of analysis. Further, by mounting the illuminator and the dispensing unit to the same shaft, it is possible to make the analyzer compact.

The third support shaft may be configured to drive the first support shaft in the third direction. The second support shaft may be configured to drive the stage in the second direction. The first support shaft may be configured to drive the dispensing unit in the first direction. The analyzer may further include a tilt mechanism which is supported by the first support shaft and which is configured to tilt the dispensing unit with respect to the first direction.

With this configuration, by tilting the dispensing unit with the use of the tilt mechanism, it allows the dispensing nozzle to reach the target, without moving the illuminator. Since it would not be necessary to move the illuminator, the analyzer may be made more compact.

According to still another embodiment of the present disclosure, there is provided a method for controlling a dispensing apparatus, in which method a dispensing unit supports a dispensing nozzle, provides the dispensing nozzle with a material to be dispensed, and allows the dispensing nozzle to discharge the material.

In this method, a drive mechanism changes relative position between a stage and the dispensing nozzle in a second direction and a third direction, where the second direction is a horizontal direction when a first direction is substantially vertical direction, and the third direction is substantially perpendicular to the first direction and to the second direction.

This method allows accelerating the diffusion of the dispensed material into the material of the target, and the level of diffusion can be uniformized as well, as described above. Furthermore, it can prevent damages to the sample which is due to the dispensed material.

As described above, the embodiments of the present disclosure make it possible to provide a dispensing apparatus, an analyzer, and a method for controlling a dispensing apparatus which are capable of allowing a material being dispensed to be diffused into a material of a target immediately under uniform conditions.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic diagram showing a dispensing apparatus according to a first embodiment;

FIGS. 2A to 2C are schematic diagrams showing an operation of the dispensing apparatus;

FIGS. 3A and 3B are schematic diagrams showing an operation of the dispensing apparatus;

FIG. 4 is a schematic diagram showing a dispensing apparatus according to a second embodiment;

FIG. 5 is a schematic diagram showing a dispensing apparatus according to a third embodiment;

FIG. 6 is a schematic diagram showing an analyzer according to a fourth embodiment;

FIGS. 7A and 7B are schematic diagrams showing an operation of the analyzer;

FIG. 8 is a schematic diagram showing an analyzer according to a fifth embodiment;

FIGS. 9A and 9B are schematic diagrams showing an operation of the analyzer;

FIGS. 10A to 10C are graphs of the measurement results according to Example; and

FIGS. 11A to 11C are graphs of the measurement results according to Example.

### DETAILED DESCRIPTION

Hereinafter, embodiments of the present disclosure will be described with reference to the drawings.

### First Embodiment

A dispensing apparatus according to a first embodiment of the present disclosure will be described.

(Configuration of Dispensing Apparatus)

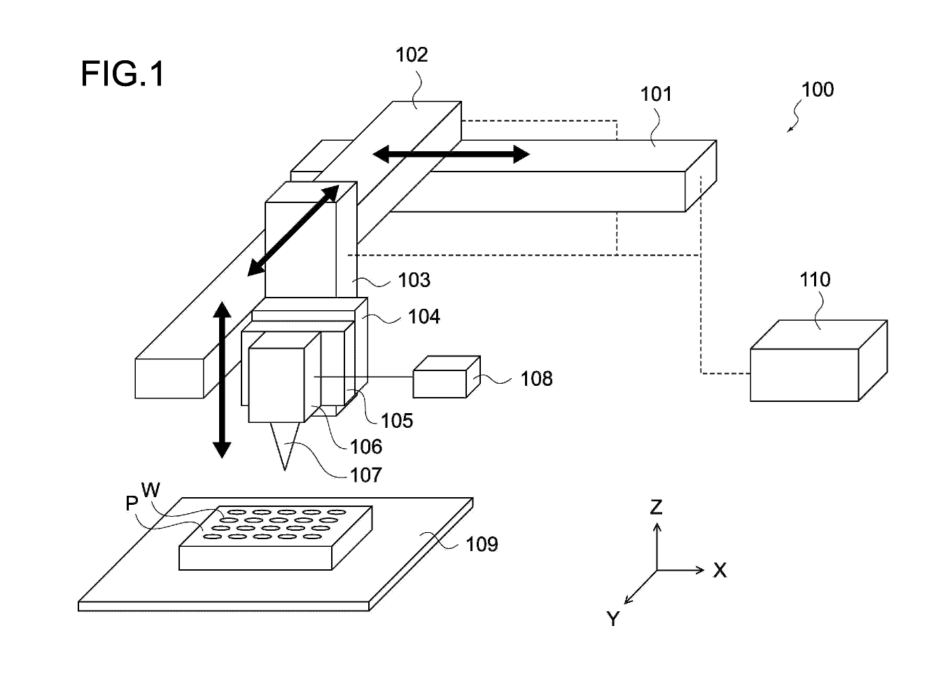

FIG. 1 is a schematic diagram showing a dispensing apparatus 100 according to this embodiment. As shown in the figure, the dispensing apparatus 100 includes an X-axis support shaft 101, a Y-axis support shaft 102, a Z-axis support shaft 103, a θ mechanism 104, a tilt mechanism 105, a dispensing unit 106, a dispensing nozzle 107, a liquid surface sensing unit 108, a stage 109 and a control unit 110. On the stage 109, there is placed a well plate P which has a plurality of wells (material-containing sections) W. In each well W, there is contained a material of a target (such as cell culture solution) to which a material to be dispensed would be dispensed.

The X-axis support shaft 101 is a support shaft which has its axis along X-direction which is a horizontal direction. For example, the X-axis support shaft 101 may be fixed to a housing (not shown) of the dispensing apparatus 100. The X-axis support shaft 101 supports the Y-axis support shaft 102 in such a manner that the Y-axis support shaft 102 is movable along its axis (X-direction). The X-axis support shaft 101 may have a built-in power source (such as a motor) that can move the Y-axis support shaft 102. Further, the X-axis support shaft 101 may be connected to the control unit 110 and may be configured to regulate the position (amount of movement) of the Y-axis support shaft 102, under the control of the control unit 110.

The Y-axis support shaft 102 is a support shaft which has its axis along Y-direction which is a horizontal direction substantially perpendicular to the X-direction. As described above, the Y-axis support shaft 102 is supported to be movable in the X-direction, by the X-axis support shaft 101. The Y-axis support shaft 102 supports the Z-axis support shaft 103 in such a manner that the Z-axis support shaft 103 is movable along its axis (Y-direction). The Y-axis support shaft 102 may have a built-in power source (such as a motor) that can move the Z-axis support shaft 103. Further, the Y-axis support shaft 102 may be connected to the control unit 110 and may be configured to regulate the position (amount of movement) of the Z-axis support shaft 103, under the control of the control unit 110.

The Z-axis support shaft 103 is a support shaft which has its axis along Z-direction which is substantially the vertical direction. As described above, the Z-axis support shaft 103 is supported to be movable in the Y-direction, by the Y-axis support shaft 102. The Z-axis support shaft 103 supports the dispensing unit 106 and the like (the θ mechanism 104, the tilt mechanism 105, the dispensing unit 106 and the dispensing nozzle 107) in such a manner that the dispensing unit 106 and the like are movable along its axis (Z-direction). The Z-axis support shaft 103 may have a built-in power source (such as a motor) that can move the dispensing unit 106 and the like. Further, the Z-axis support shaft 103 may be connected to the control unit 110 and may be configured to regulate the position (amount of movement) of the dispensing unit 106 and the like, under the control of the control unit 110.

The θ mechanism 104 supports the tilt mechanism 105 and the like (the tilt mechanism 105, the dispensing unit 106, and the dispensing nozzle 107). The θ mechanism 104 may be configured to allow the tilt mechanism 105 and the like to move in circular motion (described later), as an alternative to the X-axis support shaft 101 and the Y-axis support shaft 102. The θ mechanism 104 may be connected to the control unit 110 and may be under the control of the control unit 110.

The tilt mechanism 105 supports the dispensing unit 106 and the like (the dispensing unit 106 and the dispensing nozzle 107). The tilt mechanism 105 is configured to be capable of tilting the dispensing unit 106 and the like with respect to Z-direction. The tilt mechanism 105 may be connected to the control unit 110 and may be configured to regulate the tilt of the dispensing unit 106 and the like, under the control of the control unit 110.

The dispensing unit 106 is configured to support the dispensing nozzle 107, provide the dispensing nozzle 107 with a material to be dispensed, and allow the dispensing nozzle 107 to discharge a predetermined amount of the material to be dispensed. The material to be dispensed may be a liquid such as reagents. The dispensing unit 106 may be configured to store the material, or may get a separately stored material through a tube or the like. The dispensing unit 106 may be connected to the control unit 110 and may be configured so that the discharge amount and discharge timing of the material discharged from the dispensing unit 106 can be controlled by the control unit 110. Incidentally, as the dispensing unit 106, one which is detachable so as to be replaced with an adaptable one depending on the kind of the material to be dispensed may be suitable. Further, a plurality of dispensing units 106 may be provided to the dispensing apparatus 100.

The dispensing nozzle 107 is configured to discharge the material provided from the dispensing unit 106. The dispensing nozzle 107 is disposed opposite to the stage 109 in the vertical direction (Z-direction). A plurality of dispensing nozzles 107 may be provided to the dispensing apparatus 100, and for example, the number of the dispensing nozzles 107 may be corresponding to the arrangement of wells of the well plate P.

The liquid surface sensing unit 108 is configured to detect a liquid surface of a liquid (material of the target) contained in the well W of the well plate P. Specifically, the liquid surface sensing unit 108 includes a pressure sensor and a disturbance pump, and is configured to apply disturbance to the space inside the dispensing unit 106 by the disturbance pump. When the dispensing nozzle 107 is brought into contact with the liquid surface of the material of the target, the pressure of the space inside the dispensing unit 106 is changed, and this causes a change in the disturbance which has been applied. The liquid surface sensing unit 108 is capable of detecting this change in the disturbance by the pressure sensor, to thereby detect that the dispensing nozzle 107 has come into contact with the liquid surface. Alternatively, the liquid surface sensing unit 108 may be configured to detect the liquid surface in a different way. Upon detecting the liquid surface of the material of the target, the liquid surface sensing unit 108 notifies it to the control unit 110.

The stage 109 has a stage surface which extends horizontally (in X-Y directions), and supports the well plate P placed on the stage surface. The stage 109 may be fixed to the housing of the dispensing apparatus 100, or may be configured to be movable with respect to the housing. Further, the stage 109 may be provided with a configuration for maintaining a culture environment of the well plate P.

The control unit 110 may be an information processing unit incorporated in the dispensing apparatus 100, or may be an information processor provided independently of the dispensing apparatus 100. The control unit 110 is connected to at least the X-axis support shaft 101, the Y-axis support shaft 102, the Z-axis support shaft 103 and the dispensing unit 106; and is configured to control them. Specifically, the control unit 110 may be configured to control the power sources each provided to the X-axis support shaft 101, the Y-axis support shaft 102, and the Z-axis support shaft 103, to regulate the amount of movement thereof. This regulates relative position between the dispensing nozzle 107 and the stage 109 in vertical (Z-direction) and horizontal directions (X-Y directions).

Further, the control unit 110 may be configured to control the supply timing and supply amount of the material to be dispensed which would be provided to the dispensing nozzle 107 from the dispensing unit 106, to thereby regulate the discharge amount and discharge timing of the material discharged by the dispensing nozzle 107. At this time, the control unit 110 may use the result of detection of the liquid surface, provided by the liquid surface sensing unit 108. In addition, the control unit 110 may be configured to control the θ mechanism 104 and the tilt mechanism 105 as necessary, which may regulate the relative position and tilt angle of the dispensing nozzle 107 with respect to the stage 109.

(Operation of Dispensing Apparatus)

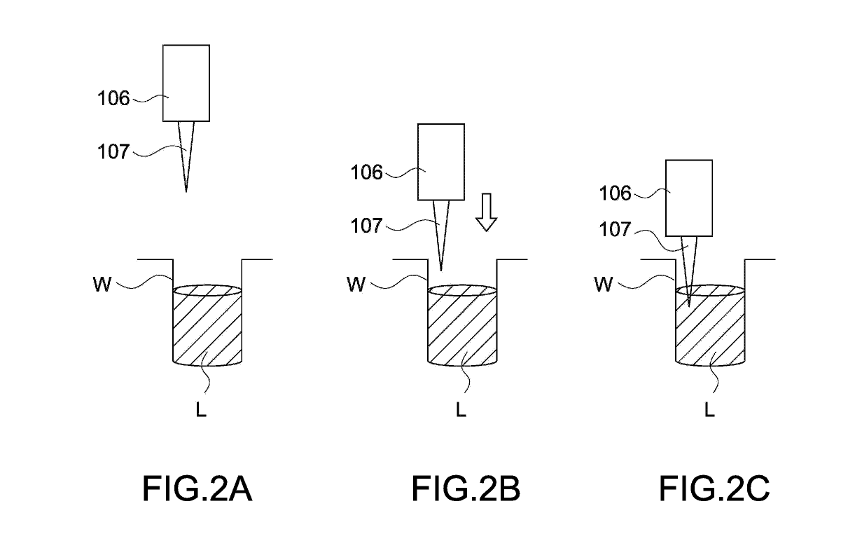

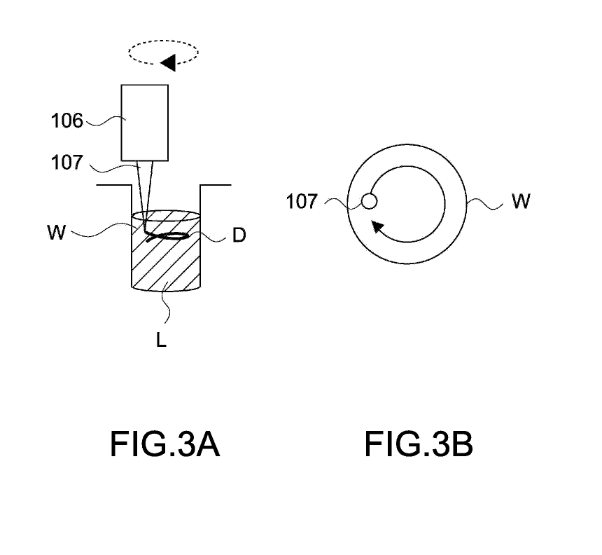

An operation of the dispensing apparatus 100 that has the above-described configuration will now be described. FIGS. 2A to 2C, 3A, and 3B are schematic diagrams showing an operation of the dispensing apparatus 100, which describe the dispensing unit 106, the dispensing nozzle 107 and a well W of the well plate P. In the well W, there is contained a material of the target L.

FIG. 2A shows a state where the well plate P is placed on the stage 109. As shown in the figure, the well plate P would be disposed so that the well W and the dispensing nozzle 107 are opposite each other in Z-direction. Alternatively, positioning of the well W and the dispensing nozzle 107 may be carried out by a user, after the well plate P has been placed on the stage 109.

At the beginning of the dispensing operation, the control unit 110 controls the power source of the Z-axis support shaft 103 to move the dispensing nozzle 107 vertically downward (Z-direction), as shown in FIG. 2B. At the same time, an external disturbance pressure by the liquid surface sensing unit 108 would be applied to the dispensing unit 106.

As shown in FIG. 2C, when the dispensing nozzle 107 is brought into contact with the liquid surface of the material of the target L, the liquid surface sensing unit 108 detects a pressure change inside the dispensing unit 106, and notifies it to the control unit 110. Upon receiving this notification, the control unit 110 stops the operation of the power source of the Z-axis support shaft 103 and allows the dispensing nozzle 107 to be at rest. Incidentally, the user may also carry out, instead of the liquid surface sensing unit 108 and the control unit 110, the operations up to this point.

Subsequently, the control unit 110 controls the power sources of the X-axis support shaft 101 and the Y-axis support shaft 102 to make the dispensing nozzle 107 move horizontally (in X-Y directions), with respect to the stage 109. FIGS. 3A and 3B are schematic diagrams showing the movement of the dispensing nozzle 107. FIG. 3A is a side view, and FIG. 3B is a top view thereof. As shown in the figures, the control unit 110 is able to control the power sources of the X-axis support shaft 101 and the Y-axis support shaft 102 in such a manner that the dispensing nozzle 107 is made to move in a circular motion around the vertical direction (Z-direction) as the rotation axis.

The control unit 110 allows, simultaneously with changing the position of the dispensing nozzle 107, controlling the dispensing unit 106 to cause the dispensing nozzle 107 to discharge the material. In FIG. 3A, there is shown a dispensed material D discharged from the dispensing nozzle 107. As the dispensing nozzle 107 is made to move in a circular motion while discharging the material D, it allows the material D to be discharged along the path of the circular motion of the dispensing nozzle 107.

This allows the dispensed material D to be diffused into the material of the target L more easily, without concentrating at one place. Further, by the circular motion of the dispensing nozzle 107, the material of the target L is stirred at the same time as the material D is discharged, and thus the dispensed material D is more easily mixed with the material of the target L. In addition, since the dispensed material D is not discharged at one place, it prevents damages by the dispensed material D to the sample (such as cells), or the like, immobilized at the bottom surface of the well W. If the user is supposed to perform such a dispensing operation, since the skills of allowing the material to be discharged while moving the pipet or the like would be necessary, differences by the user may occur, and thus it is difficult to provide uniform experimental conditions. In contrast to this, the dispensing apparatus 100 allows the material to be dispensed to be uniformly discharged, that is, it is possible to provide uniform experimental conditions.

Incidentally, the rotational speed of the dispensing nozzle 107 is able to be appropriately adjusted depending on the amount of the material to be dispensed, and depending on the affinity or the like of the material to be dispensed and the liquid target L. For example, the rotational speed may be approximately from one to several hertz (Hz). As will be described in detail later, by increasing the rotational speed of the dispensing nozzle 107, it can accelerate the mixing of the dispensed material D into the material of the target L.

In addition, the control unit 110 may control the θ mechanism 104, as an alternative to the X-axis support shaft 101 and the Y-axis support shaft 102, to make the dispensing nozzle 107 move horizontally (in X-Y directions). Further, the control unit 110 may control the tilt mechanism 105 to allow discharging the material by the dispensing nozzle 107 while the dispensing nozzle 107 is tilted with respect to the vertical direction (Z-direction).

The dispensing apparatus 100 of this embodiment operates as described above. Since the dispensing apparatus 100 allows discharging the material to be dispensed while moving the dispensing nozzle 107 at the same time, as described above, it is capable of allowing the material being dispensed to be diffused into the material of the target immediately. In addition, as the mechanism for moving the dispensing nozzle 107 of the dispensing apparatus 100 is independent of the stage 109, it is possible to prevent vibrations from this mechanism from being applied to the material of the target.

### Second Embodiment

A dispensing apparatus according to a second embodiment of the present disclosure will be described.

(Configuration of Dispensing Apparatus)

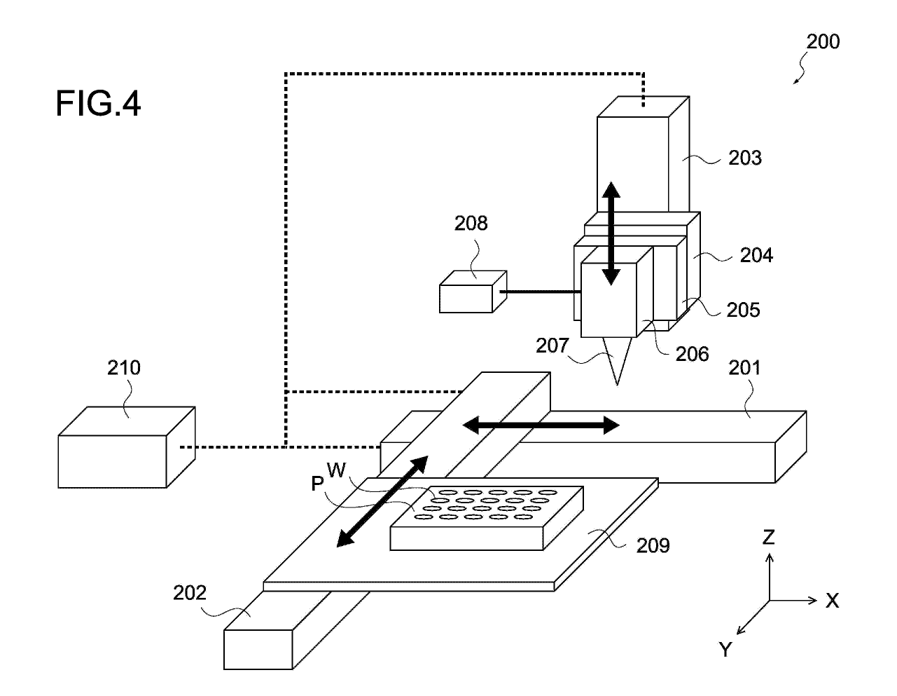

FIG. 4 is a schematic diagram showing a dispensing apparatus 200 according to this embodiment. As shown in the figure, the dispensing apparatus 200 includes an X-axis support shaft 201, a Y-axis support shaft 202, a Z-axis support shaft 203, a θ mechanism 204, a tilt mechanism 205, a dispensing unit 206, a dispensing nozzle 207, a liquid surface sensing unit 208, a stage 209 and a control unit 210. On the stage 209, there is placed a well plate P which has a plurality of wells W. In each well W, there is contained a material of a target to which a material to be dispensed would be dispensed.

The X-axis support shaft 201 is a support shaft which has its axis along X-direction which is a horizontal direction. For example, the X-axis support shaft 201 may be fixed to a housing (not shown) of the dispensing apparatus 200. The X-axis support shaft 201 supports the Y-axis support shaft 202 in such a manner that the Y-axis support shaft 202 is movable along its axis (X-direction). The X-axis support shaft 201 may have a built-in power source (such as a motor) that can move the Y-axis support shaft 202. Further, the X-axis support shaft 201 may be connected to the control unit 210 and may be configured to regulate the position (amount of movement) of the Y-axis support shaft 202, under the control of the control unit 210.

The Y-axis support shaft 202 is a support shaft which has its axis along Y-direction which is a horizontal direction substantially perpendicular to the X-direction. As described above, the Y-axis support shaft 202 is supported to be movable in the X-direction, by the X-axis support shaft 201. The Y-axis support shaft 202 supports the stage 209 in such a manner that the stage 209 is movable along its axis (Y-direction). The Y-axis support shaft 202 may have a built-in power source (such as a motor) that can move the stage 209. Further, the Y-axis support shaft 202 may be connected to the control unit 210 and may be configured to regulate the position (amount of movement) of the stage 209, under the control of the control unit 210.

The Z-axis support shaft 203 is a support shaft which has its axis along Z-direction which is substantially the vertical direction. The Z-axis support shaft 203 may be fixed to the housing (not shown) of the dispensing apparatus 200. The Z-axis support shaft 203 supports the dispensing unit 206 and the like (the θ mechanism 204, the tilt mechanism 205, the dispensing unit 206 and the dispensing nozzle 207) in such a manner that the dispensing unit 206 and the like are movable along its axis (Z-direction). The Z-axis support shaft 203 may have a built-in power source (such as a motor) that can move the dispensing unit 206 and the like. Further, the Z-axis support shaft 203 may be connected to the control unit 210 and may be configured to regulate the position (amount of movement) of the dispensing unit 206 and the like, under the control of the control unit 210.

The θ mechanism 204, the tilt mechanism 205, the dispensing unit 206, the dispensing nozzle 207 and the liquid surface sensing unit 208 may have substantially the same configurations as the first embodiment. That is, the θ mechanism 204 is configured to allow the tilt mechanism 205 and the like to move in circular motion, and the tilt mechanism 205 is configured to be capable of tilting the dispensing unit 206 and the like with respect to the vertical direction (Z-direction). The dispensing unit 206 is configured to support the dispensing nozzle 207, provide the dispensing nozzle 207 with a material to be dispensed under the control of the control unit 210, and allow the dispensing nozzle 207 to discharge the material. The liquid surface sensing unit 208 is configured to detect a liquid surface of a liquid (material of the target) contained in the well W of the well plate P, and then notify it to the control unit 210.

The stage 209 has a stage surface which extends horizontally (in X-Y directions), and supports the well plate P placed on the stage surface. The stage 209 is supported by the Y-axis support shaft 202, and is configured to be movable, by the Y-axis support shaft 202, along the axis thereof (Y-direction). Further, the stage 209 may be provided with a configuration for maintaining a culture environment of the well plate P.

The control unit 210 may be an information processing unit incorporated in the dispensing apparatus 200, or may be an information processor provided independently of the dispensing apparatus 200. The control unit 210 is connected to at least the X-axis support shaft 201, the Y-axis support shaft 202, the Z-axis support shaft 203 and the dispensing unit 206; and is configured to control them. Specifically, the control unit 210 may be configured to control the power sources each provided to the X-axis support shaft 201, the Y-axis support shaft 202, and the Z-axis support shaft 203, to regulate the amount of movement thereof. This regulates relative position between the dispensing nozzle 207 and the stage 209 in vertical (Z-direction) and horizontal directions (X-Y directions).

Further, the control unit 210 may be configured to control the supply timing and supply amount of the material to be dispensed which would be provided to the dispensing nozzle 207 from the dispensing unit 206, to thereby regulate the discharge amount and discharge timing of the material discharged by the dispensing nozzle 207. At this time, the control unit 210 may use the result of detection of the liquid surface, provided by the liquid surface sensing unit 208. In addition, the control unit 210 may be configured to control the θ mechanism 204 and the tilt mechanism 205 as necessary, which may regulate the position and tilt angle of the dispensing nozzle 207 with respect to the stage 209.

(Operation of Dispensing Apparatus)

An operation of the dispensing apparatus 200 that has the above-described configuration will now be described. Similarly to the first embodiment, at the beginning of the dispensing operation, the control unit 210 controls the power source of the Z-axis support shaft 203 to move the dispensing nozzle 207 vertically downward (Z-direction). The control unit 210 allows the dispensing nozzle 207 to move until it comes into contact with the liquid surface of the material of the target, using the liquid surface sensing unit 208.

Subsequently, the control unit 210 controls the power sources of the X-axis support shaft 201 and the Y-axis support shaft 202 to move the stage 209 horizontally (in X-Y plane directions). The control unit 210 is able to control the power sources of the X-axis support shaft 201 and the Y-axis support shaft 202 in such a manner that the stage 209 is made to move in a circular motion around the vertical direction (Z-direction) as the rotation axis, with respect to the dispensing nozzle 207.

The control unit 210 allows, simultaneously with changing the position of the stage 209, controlling the dispensing unit 206 to cause the dispensing nozzle 207 to discharge the material. As the stage 209 is made to move in a circular motion in the state where the dispensing nozzle 207 is discharging the material, it allows the material to be discharged along the path of the circular motion of the stage 209.

In addition, the control unit 210 may control the θ mechanism 204, as an alternative to the X-axis support shaft 201 and the Y-axis support shaft 202, to make the dispensing nozzle 207 move horizontally (in X-Y directions). Further, the control unit 210 may control the tilt mechanism 205 to allow discharging the material by the dispensing nozzle 207 while the dispensing nozzle 207 is tilted with respect to the vertical direction (Z-direction).

The dispensing apparatus 200 of this embodiment operates as described above. Similarly to the first embodiment, since the dispensing apparatus 200 allows discharging the material to be dispensed while moving the stage 209 at the same time, as described above, it is capable of allowing the material being dispensed to be diffused into the material of the target immediately. In addition, in the dispensing apparatus 200, the mechanism for moving the stage 209 horizontally (in X-Y directions) is disposed at the stage 209 side, and what is disposed at the dispensing unit 206 side is the mechanism which only moves the dispensing unit 206 in the vertical direction (Z-direction). Therefore, the drive mechanism at the side of the dispensing nozzle 207 can be made compact and light in weight.

### Third Embodiment

A dispensing apparatus according to a third embodiment of the present disclosure will be described.

(Configuration of Dispensing Apparatus)

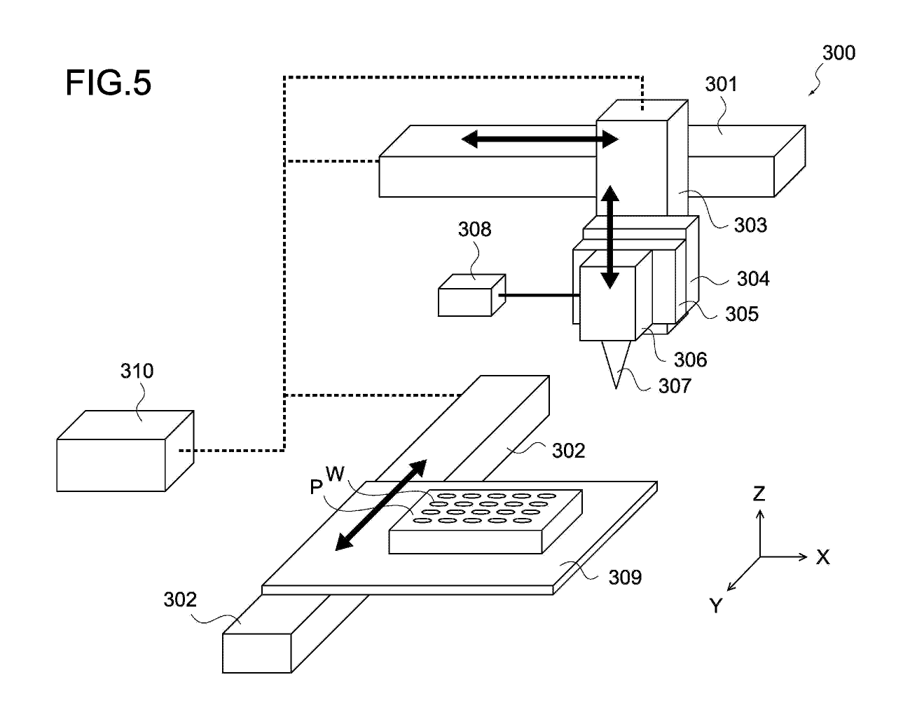

FIG. 5 is a schematic diagram showing a dispensing apparatus 300 according to this embodiment. As shown in the figure, the dispensing apparatus 300 includes an X-axis support shaft 301, a Y-axis support shaft 302, a Z-axis support shaft 303, a θ mechanism 304, a tilt mechanism 305, a dispensing unit 306, a dispensing nozzle 307, a liquid surface sensing unit 308, a stage 309 and a control unit 310. On the stage 309, there is placed a well plate P which has a plurality of wells W. In each well W, there is contained a material of a target to which a material to be dispensed would be dispensed.

The X-axis support shaft 301 is a support shaft which has its axis along X-direction which is a horizontal direction. For example, the X-axis support shaft 301 may be fixed to a housing (not shown) of the dispensing apparatus 300. The X-axis support shaft 301 supports the Z-axis support shaft 303 in such a manner that the Z-axis support shaft 303 is movable along its axis (X-direction). The X-axis support shaft 301 may have a built-in power source (such as a motor) that can move the Z-axis support shaft 303. Further, the X-axis support shaft 301 may be connected to the control unit 310 and may be configured to regulate the position (amount of movement) of the Z-axis support shaft 303, under the control of the control unit 310.

The Y-axis support shaft 302 is a support shaft which has its axis along Y-direction which is a horizontal direction substantially perpendicular to the X-direction. For example, the Y-axis support shaft 302 may be fixed to the housing (not shown) of the dispensing apparatus 300. The Y-axis support shaft 302 supports the stage 309 in such a manner that the stage 309 is movable along its axis (Y-direction). The Y-axis support shaft 302 may have a built-in power source (such as a motor) that can move the stage 309. Further, the Y-axis support shaft 302 may be connected to the control unit 310 and may be configured to regulate the position (amount of movement) of the stage 309, under the control of the control unit 310.

The Z-axis support shaft 303 is a support shaft which has its axis along Z-direction which is substantially the vertical direction. As described above, the Z-axis support shaft 303 is supported to be movable in the X-direction, by the X-axis support shaft 301. The Z-axis support shaft 303 supports the dispensing unit 306 and the like (the θ mechanism 304, the tilt mechanism 305, the dispensing unit 306 and the dispensing nozzle 307) in such a manner that the dispensing unit 306 and the like are movable along its axis (Z-direction). The Z-axis support shaft 303 may have a built-in power source (such as a motor) that can move the dispensing unit 306 and the like. Further, the Z-axis support shaft 303 may be connected to the control unit 310 and may be configured to regulate the position (amount of movement) of the dispensing unit 306 and the like, under the control of the control unit 310.

The θ mechanism 304, the tilt mechanism 305, the dispensing unit 306, the dispensing nozzle 307 and the liquid surface sensing unit 308 may have substantially the same configurations as the first embodiment. That is, the θ mechanism 304 is configured to allow the tilt mechanism 305 and the like to move in circular motion, and the tilt mechanism 305 is configured to be capable of tilting the dispensing unit 306 and the like with respect to the vertical direction (Z-direction). The dispensing unit 306 is configured to support the dispensing nozzle 307, provide the dispensing nozzle 307 with a material to be dispensed under the control of the control unit 310, and allow the dispensing nozzle 307 to discharge the material. The liquid surface sensing unit 308 is configured to detect a liquid surface of a liquid (material of the target) contained in the well W of the well plate P, and then notify it to the control unit 310.

The stage 309 has a stage surface which extends horizontally (in X-Y directions), and supports the well plate P placed on the stage surface. The stage 309 is supported by the Y-axis support shaft 302, and is configured to be movable, by the Y-axis support shaft 302, along the axis thereof (Y-direction). Further, the stage 309 may be provided with a configuration for maintaining a culture environment of the well plate P.

The control unit 310 may be an information processing unit incorporated in the dispensing apparatus 300, or may be an information processor provided independently of the dispensing apparatus 300. The control unit 310 is connected to at least the X-axis support shaft 301, the Y-axis support shaft 302, the Z-axis support shaft 303 and the dispensing unit 306; and is configured to control them. Specifically, the control unit 310 may be configured to control the power sources each provided to the X-axis support shaft 301, the Y-axis support shaft 302, and the Z-axis support shaft 303, to regulate the amount of movement thereof. This regulates relative position between the dispensing nozzle 307 and the stage 309 in vertical (Z-direction) and horizontal directions (X-Y directions).

Further, the control unit 310 may be configured to control the supply timing and supply amount of the material to be dispensed which would be provided to the dispensing nozzle 307 from the dispensing unit 306, to thereby regulate the discharge amount and discharge timing of the material discharged by the dispensing nozzle 307. At this time, the control unit 310 may use the result of detection of the liquid surface, provided by the liquid surface sensing unit 308. In addition, the control unit 310 may be configured to control the θ mechanism 304 and the tilt mechanism 305 as necessary, which may regulate the position and tilt angle of the dispensing nozzle 307 with respect to the stage 309.

(Operation of Dispensing Apparatus)

An operation of the dispensing apparatus 300 that has the above-described configuration will now be described. Similarly to the first embodiment, at the beginning of the dispensing operation, the control unit 310 controls the power source of the Z-axis support shaft 303 to move the dispensing nozzle 307 vertically downward (Z-direction). The control unit 310 allows the dispensing nozzle 307 to move until it comes into contact with the liquid surface of the material of the target, using the liquid surface sensing unit 308.

Subsequently, the control unit 310 controls the power sources of the X-axis support shaft 301 and the Y-axis support shaft 302 to move the dispensing nozzle 307 and the stage 309 horizontally (in X-Y plane directions). The control unit 310 is able to control the power sources of the X-axis support shaft 301 and the Y-axis support shaft 302 in such a manner that the dispensing nozzle 307 and the stage 309 are made to move in relative circular motion around the vertical direction (Z-direction) as the rotation axis.

The control unit 310 allows, simultaneously with changing the position of the dispensing nozzle 307 and the stage 309, controlling the dispensing unit 306 to cause the dispensing nozzle 307 to discharge the material. As the dispensing nozzle 307 and the stage 309 are made to move in respective circular motion in the state where the dispensing nozzle 307 is discharging the material, it allows the material to be discharged along the path of the circular motion.

In addition, the control unit 310 may control the θ mechanism 304, as an alternative to the X-axis support shaft 301 and the Y-axis support shaft 302, to make the dispensing nozzle 307 move horizontally (in X-Y directions). Further, the control unit 310 may control the tilt mechanism 305 to allow discharging the material by the dispensing nozzle 307 while the dispensing nozzle 307 is tilted with respect to the vertical direction (Z-direction).

The dispensing apparatus 300 of this embodiment operates as described above. Similarly to the first and the second embodiments, since the dispensing apparatus 300 allows discharging the material to be dispensed while moving the dispensing nozzle 307 and the stage 309 at the same time, as described above, it is capable of allowing the material being dispensed to be diffused into the material of the target immediately. In addition, as the X-axis support shaft 301 is disposed at the dispensing unit 306 and the Y-axis support shaft 302 is disposed at the stage 309, the drive mechanism in the dispensing apparatus 300 can be arranged in a balanced manner.

### Fourth Embodiment

An analyzer according to a fourth embodiment of the present disclosure will be described.

(Configuration of Analyzer)

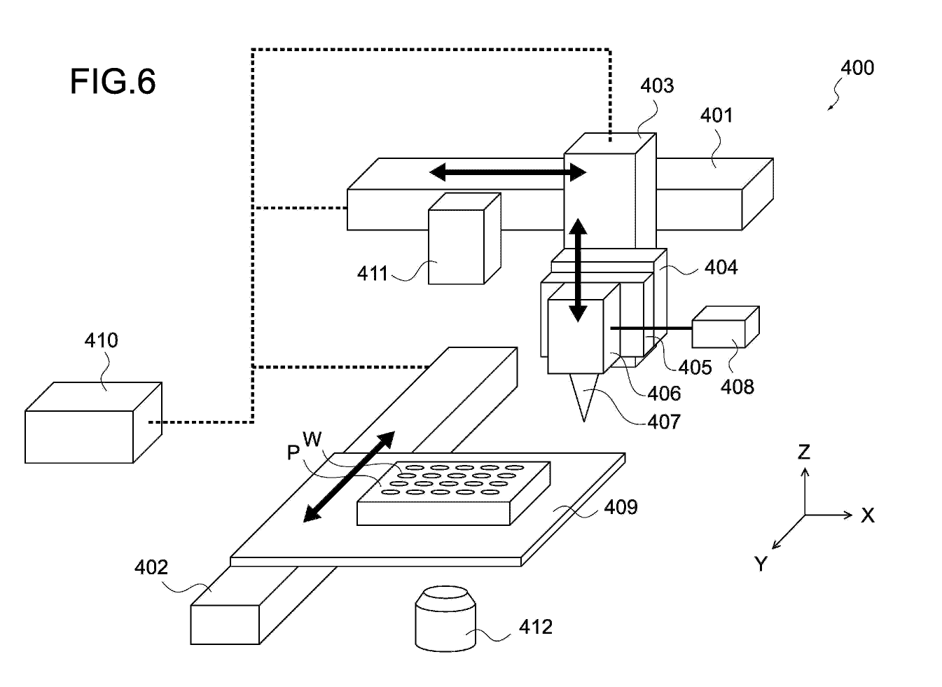

FIG. 6 is a schematic diagram showing an analyzer 400 according to this embodiment. As shown in the figure, the analyzer 400 includes an X-axis support shaft 401, a Y-axis support shaft 402, a Z-axis support shaft 403, a θ mechanism 404, a tilt mechanism 405, a dispensing unit 406, a dispensing nozzle 407, a liquid surface sensing unit 408, a stage 409, a control unit 410, an illuminator 411 and a microscope optical system 412. On the stage 409, there is placed a well plate P which has a plurality of wells W. In each well W, there is contained an object of analysis (such as cells) and a material of a target (such as cell culture solution) to which a material to be dispensed would be dispensed.

The X-axis support shaft 401 is a support shaft which has its axis along X-direction which is a horizontal direction. For example, the X-axis support shaft 401 may be fixed to a housing (not shown) of the analyzer 400. The X-axis support shaft 401 supports the Z-axis support shaft 403 and the illuminator 411 in such a manner that the Z-axis support shaft 403 and the illuminator 411 are movable along its axis (X-direction). The X-axis support shaft 401 may have a built-in power source (such as a motor) that can move the Z-axis support shaft 403 and the illuminator 411. The power source may be configured to allow the Z-axis support shaft 403 and the illuminator 411 to move without changing the relative position between the two. Further, the X-axis support shaft 401 may be connected to the control unit 410 and may be configured to regulate the position (amount of movement) of the Z-axis support shaft 403 and the illuminator 411, under the control of the control unit 410.

The Y-axis support shaft 402 and the Z-axis support shaft 403 may be configured substantially the same as the third embodiment. That is, the Y-axis support shaft 402 supports the stage 409 in such a manner that the stage 409 is movable along its axis (Y-direction), and the Z-axis support shaft 403 supports the dispensing unit 406 and the like in such a manner that the dispensing unit 406 and the like are movable along its axis (Z-direction). The Y-axis support shaft 402 and the Z-axis support shaft 403 may have respective built-in power sources which are configured so that their respective amounts of movement are controlled by the control unit 410.

The θ mechanism 404, the tilt mechanism 405, the dispensing unit 406, the dispensing nozzle 407 and the liquid surface sensing unit 408 may have substantially the same configurations as the first embodiment. That is, the θ mechanism 404 is configured to allow the tilt mechanism 405 and the like to move in circular motion, and the tilt mechanism 405 is configured to be capable of tilting the dispensing unit 406 and the like with respect to the vertical direction (Z-direction). The dispensing unit 406 is configured to support the dispensing nozzle 407, provide the dispensing nozzle 407 with a material to be dispensed under the control of the control unit 410, and allow the dispensing nozzle 407 to discharge the material. The liquid surface sensing unit 408 is configured to detect a liquid surface of a liquid (material of the target) contained in the well W of the well plate P, and then notify it to the control unit 410.

The stage 409 has a stage surface which extends horizontally (in X-Y directions), and supports the well plate P placed on the stage surface. The stage 409 is supported by the Y-axis support shaft 402, and is configured to be movable along the axis of the Y-axis support shaft 402 (Y-direction). Further, the stage 409 may be provided with a configuration for maintaining a culture environment of the well plate P.

The control unit 410 may be an information processing unit incorporated in the analyzer 400, or may be an information processor provided independently of the analyzer 400. The control unit 410 is connected to at least the X-axis support shaft 401, the Y-axis support shaft 402, the Z-axis support shaft 403 and the dispensing unit 406; and is configured to control them. Specifically, the control unit 410 may be configured to control the power sources each provided to the X-axis support shaft 401, the Y-axis support shaft 402, and the Z-axis support shaft 403, to regulate the amount of movement thereof. This regulates relative position between the dispensing nozzle 407 and the stage 409 in vertical (Z-direction) and horizontal directions (X-Y directions). Furthermore, in this embodiment, the position of the illuminator 411 supported by the X-axis support shaft 401, in X-direction, with respect to the stage 409 is also regulated by the control unit 410.

Further, the control unit 410 may be configured to control the supply timing and supply amount of the material to be dispensed which would be provided to the dispensing nozzle 407 from the dispensing unit 406, to thereby regulate the discharge amount and discharge timing of the material discharged by the dispensing nozzle 407. At this time, the control unit 410 may use the result of detection of the liquid surface, provided by the liquid surface sensing unit 408. In addition, the control unit 410 may be configured to control the θ mechanism 404 and the tilt mechanism 405 as necessary, which may regulate the position and tilt angle of the dispensing nozzle 407 with respect to the stage 409.

The illuminator 411 is supported by the X-axis support shaft 401, and is configured to illuminate the well plate P with illumination light. The illuminator 411 may be any illuminating means such as a halogen lamp. The illuminator 411 is configured to be movable by the X-axis support shaft 401, to move with respect to the stage 409, maintaining its relative position with respect to the Z-axis support shaft 403.

The microscope optical system 412 is configured to magnify the illumination light which is emitted from the illuminator 411 and has passed through the well plate P (the object of analysis contained therein). A configuration of the microscope optical system 412 is not especially limited. Further, as an alternative to the microscope optical system 412, other means of analyzing may also be used.

(Operation of Analyzer)

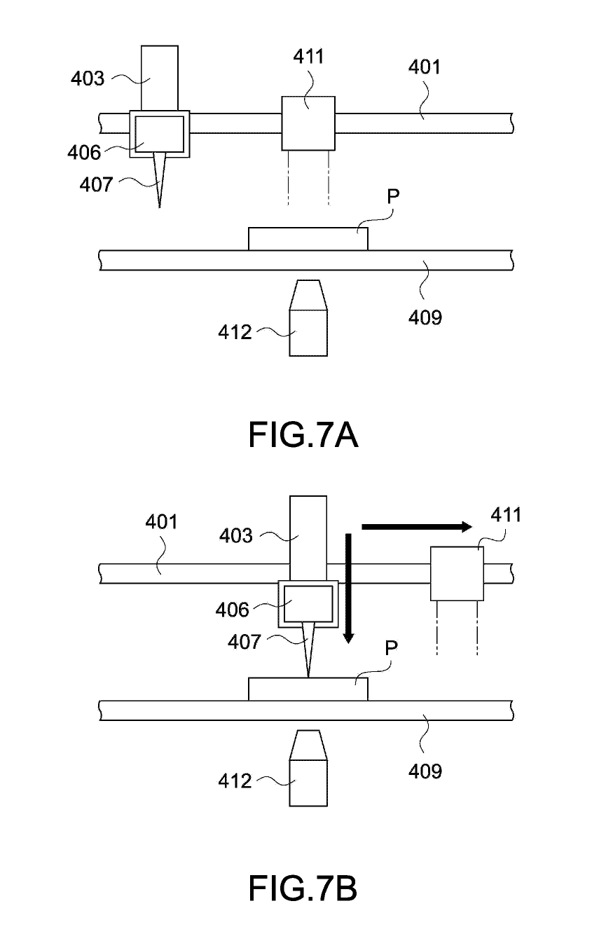

An operation of the analyzer 400 that has the above-described configuration will now be described. FIGS. 7A and 7B are schematic diagrams showing an operation of the analyzer 400.

As shown in FIG. 7A, the power source of the X-axis support shaft 401 is controlled by the control unit 410, and it moves the illuminator 411 to the position opposite to the well plate P. In this state, the illuminator 411 illuminates the well plate P with the illumination light, thus enabling an observation of the object of analysis using the microscope optical system 412.

At the beginning of the dispensing operation to the target in the well W, the control unit 410 controls the power source of the X-axis support shaft 401 to move the illuminator 411 and the Z-axis support shaft 403 as shown in FIG. 7B. The control unit 410 allows the illuminator 411 to move to a position which is not opposite to the well plate P, and allows the Z-axis support shaft 403 to move to a position where the dispensing nozzle 407 becomes opposite to the well plate P.

After this, similarly to the third embodiment, the control unit 410 controls the power source of the Z-axis support shaft 403 to move the dispensing nozzle 407 vertically downward (Z-direction). The control unit 410 allows the dispensing nozzle 407 to move until it comes into contact with the liquid surface of the material of the target, using the liquid surface sensing unit 408.

Subsequently, the control unit 410 controls the power sources of the X-axis support shaft 401 and the Y-axis support shaft 402 to move the dispensing nozzle 407 and the stage 409 horizontally (in X-Y plane directions). The control unit 410 is able to control the power sources of the X-axis support shaft 401 and the Y-axis support shaft 402 in such a manner that the dispensing nozzle 407 and the stage 409 are made to move in relative circular motion around the vertical direction (Z-direction) as the rotation axis.

The control unit 410 allows, simultaneously with changing the position of the dispensing nozzle 407 and the stage 409, controlling the dispensing unit 406 to cause the dispensing nozzle 407 to discharge the material. As the dispensing nozzle 407 and the stage 409 are made to move in respective circular motion in the state where the dispensing nozzle 407 is discharging the material, it allows the material to be discharged along the path of the circular motion.

The control unit 410, after finishing the dispensing operation, is able to move the Z-axis support shaft 403 and the illuminator 411 to the original position again (FIG. 7A). This enables the observation of the object of analysis by the microscope optical system 412 to be continuously performed. Therefore, the analyzer 400 is suitable for addition of a reagent to a sample (object of analysis) and observation or the like performed thereafter.

In addition, the control unit 410 may control the θ mechanism 404, as an alternative to the X-axis support shaft 401 and the Y-axis support shaft 402, to make the dispensing nozzle 407 move horizontally (in X-Y directions). Further, the control unit 410 may control the tilt mechanism 405 to allow discharging the material by the dispensing nozzle 407 while the dispensing nozzle 407 is tilted with respect to the vertical direction (Z-direction).

The analyzer 400 of this embodiment operates as described above. Similarly to the first and the second embodiments, since the analyzer 400 allows discharging the material to be dispensed while moving the dispensing nozzle 407 and the stage 409 at the same time, as described above, it is capable of allowing the material being dispensed to be diffused into the material of the target immediately. In addition, as the illuminator 411 and the dispensing unit 406 of the analyzer 400 can be mounted together to the X-axis support shaft 401, the analyzer 400 is able to be made compact.

### Fifth Embodiment

An analyzer according to a fifth embodiment of the present disclosure will be described.

(Configuration of Analyzer)

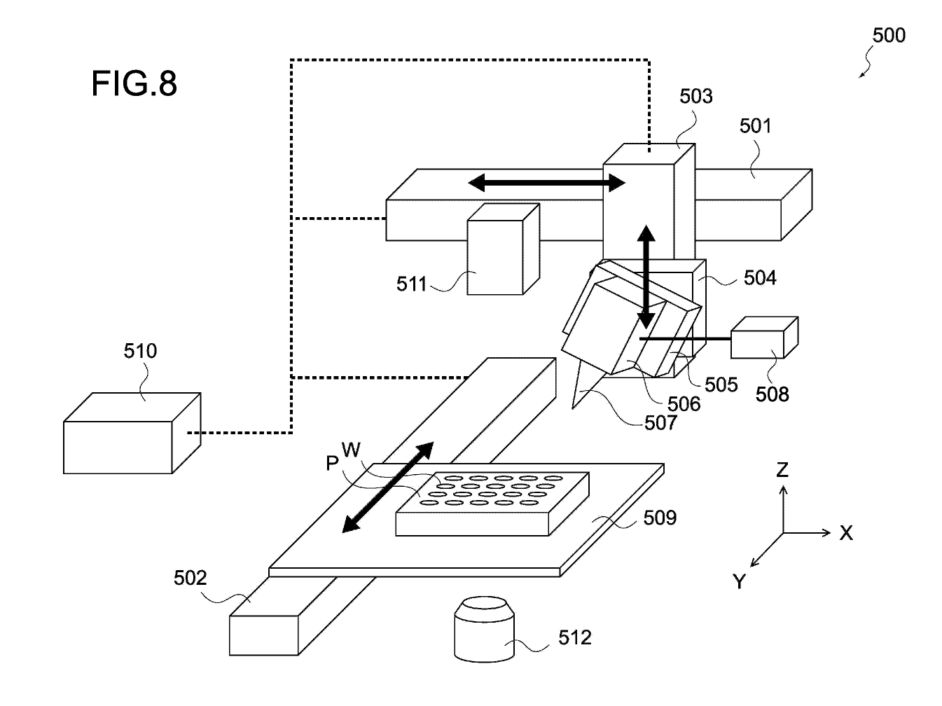

FIG. 8 is a schematic diagram showing an analyzer 500 according to this embodiment. As shown in the figure, the analyzer 500 includes an X-axis support shaft 501, a Y-axis support shaft 502, a Z-axis support shaft 503, a θ mechanism 504, a tilt mechanism 505, a dispensing unit 506, a dispensing nozzle 507, a liquid surface sensing unit 508, a stage 509, a control unit 510, an illuminator 511 and a microscope optical system 512. On the stage 509, there is placed a well plate P which has a plurality of wells W. In each well W, there is contained an object of analysis (such as cells) and a material of a target (such as cell culture solution) to which a material to be dispensed would be dispensed.

The X-axis support shaft 501 is a support shaft which has its axis along X-direction which is a horizontal direction. Hereinafter, the axis direction of the X-axis support shaft 501 will be defined as X-direction. For example, the X-axis support shaft 501 may be fixed to a housing (not shown) of the analyzer 500. The X-axis support shaft 501 supports the illuminator 511, and supports the Z-axis support shaft 503 in such a manner that the Z-axis support shaft 503 is movable along its axis (X-direction). The X-axis support shaft 501 may have a built-in power source (such as a motor) that can move the Z-axis support shaft 503. In this embodiment, the X-axis support shaft 501 can be configured without having a power source that moves the illuminator 511. The X-axis support shaft 501 may be connected to the control unit 510 and may be configured to regulate the position (amount of movement) of the Z-axis support shaft 503, under the control of the control unit 510.

The Y-axis support shaft 502 and the Z-axis support shaft 503 may be configured substantially the same as the third embodiment. That is, the Y-axis support shaft 502 supports the stage 509 in such a manner that the stage 509 is movable along its axis (Y-direction), and the Z-axis support shaft 503 supports the dispensing unit 506 and the like in such a manner that the dispensing unit 506 and the like are movable along its axis (Z-direction). The Y-axis support shaft 502 and the Z-axis support shaft 503 may have respective built-in power sources which are configured so that their respective amounts of movement are controlled by the control unit 510.

The θ mechanism 504, the tilt mechanism 505, the dispensing unit 506, the dispensing nozzle 507 and the liquid surface sensing unit 508 may have substantially the same configurations as the first embodiment. That is, the θ mechanism 504 is configured to allow the tilt mechanism 505 and the like to move in circular motion, and the tilt mechanism 505 is configured to be capable of tilting the dispensing unit 506 and the like with respect to the vertical direction (Z-direction). The dispensing unit 506 is configured to support the dispensing nozzle 507, provide the dispensing nozzle 507 with a material to be dispensed under the control of the control unit 510, and allow the dispensing nozzle 507 to discharge the material. The liquid surface sensing unit 508 is configured to detect a liquid surface of a liquid (material of the target) contained in the well W of the well plate P, and then notify it to the control unit 510.

The stage 509 has a stage surface which extends horizontally (in X-Y directions), and supports the well plate P placed on the stage surface. The stage 509 is supported by the Y-axis support shaft 502, and is configured to be movable, by the Y-axis support shaft 502, along the axis thereof (Y-direction). Further, the stage 509 may be provided with a configuration for maintaining a culture environment of the well plate P.

The control unit 510 may be an information processing unit incorporated in the analyzer 500, or may be an information processor provided independently of the analyzer 500. The control unit 510 is connected to at least the X-axis support shaft 501, the Y-axis support shaft 502, the Z-axis support shaft 503, the tilt mechanism 505 and the dispensing unit 506; and is configured to control them. Specifically, the control unit 510 may be configured to control the power sources each provided to the X-axis support shaft 501, the Y-axis support shaft 502, and the Z-axis support shaft 503, to regulate the amount of movement thereof. This regulates the position of the dispensing nozzle 507 with respect to the stage 509 in vertical (Z-direction) and horizontal directions (X-Y directions). Furthermore, in this embodiment, the control unit 510 may be configured to control the tilt mechanism 505, which may regulate the tilt angle of the dispensing nozzle 507 with respect to the vertical direction (Z-direction).

Further, the control unit 510 may be configured to control the supply timing and supply amount of the material to be dispensed which would be provided to the dispensing nozzle 507 from the dispensing unit 506, to thereby regulate the discharge amount and discharge timing of the material discharged by the dispensing nozzle 507. At this time, the control unit 510 may use the result of detection of the liquid surface, provided by the liquid surface sensing unit 508. In addition, the control unit 510 may be configured to control the θ mechanism 504 as necessary, which may regulate the position of the dispensing nozzle 507 with respect to the stage 509.

(Operation of Analyzer)

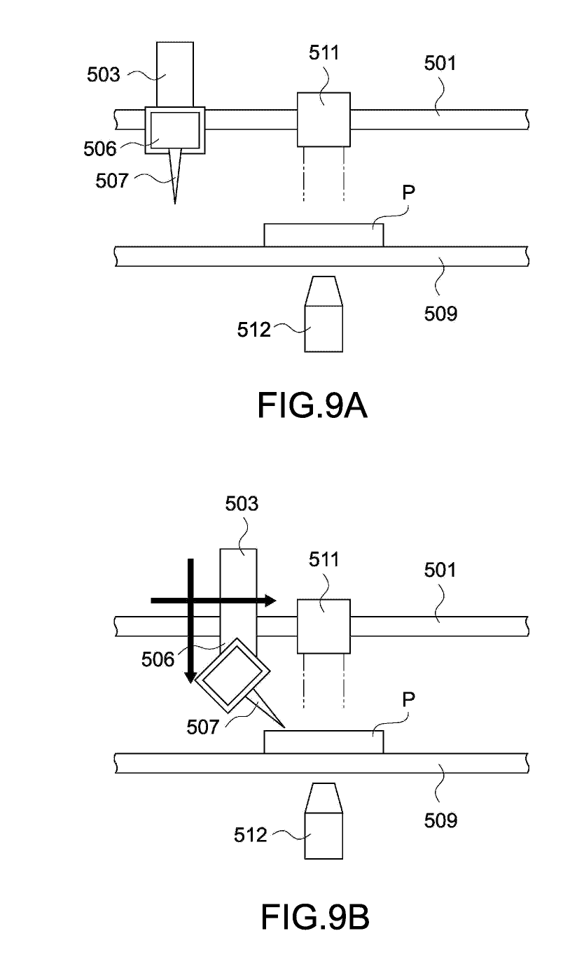

An operation of the analyzer 500 that has the above-described configuration will now be described. FIGS. 9A and 9B are schematic diagrams showing an operation of the analyzer 500.

As shown in FIG. 9A, in the state where the illuminator 511 is opposite to the well plate P, the illuminator 511 illuminates the well plate P with the illumination light, thus enabling an observation of the sample by the microscope optical system 512.

At the beginning of the dispensing operation to the target in the well W, the control unit 510 controls the power source of the X-axis support shaft 501 to move the dispensing unit 506 so that the dispensing nozzle 507 is positioned in the vicinity of the well plate P, as shown in FIG. 9B. At the same time, the control unit 510 controls the tilt mechanism 505 to tilt the dispensing nozzle 507 so that the dispensing nozzle 507 would be positioned directly above the well W.

After this, similarly to the third embodiment, the control unit 510 controls the power source of the Z-axis support shaft 503 to move the dispensing nozzle 507 vertically downward (Z-direction). The control unit 510 allows the dispensing nozzle 507 to move until it comes into contact with the liquid surface of the material of the target, using the liquid surface sensing unit 508.

Subsequently, the control unit 510 controls the power sources of the X-axis support shaft 501 and the Y-axis support shaft 502 to move the dispensing nozzle 507 and the stage 509 horizontally (in X-Y plane directions). The control unit 510 is able to control the power sources of the X-axis support shaft 501 and the Y-axis support shaft 502 in such a manner that the dispensing nozzle 507 and the stage 509 are made to move in relative circular motion around the vertical direction (Z-direction) as the rotation axis.

The control unit 510 allows, simultaneously with moving the dispensing nozzle 507 and the stage 509, controlling the dispensing unit 506 to cause the dispensing nozzle 507 to discharge the material. As the dispensing nozzle 507 and the stage 509 are made to move in respective circular motion in the state where the dispensing nozzle 507 is discharging the material, it allows the material to be discharged along the path of the circular motion.

The control unit 510, after finishing the dispensing operation, is able to move the Z-axis support shaft 503 to the original position again (FIG. 9A). This enables the observation of the object of analysis by the microscope optical system 512 to be continuously performed. Therefore, the analyzer 500 is suitable for addition of a reagent to a sample (object of analysis) and observation or the like performed thereafter.

In addition, the control unit 510 may control the θ mechanism 504, as an alternative to the X-axis support shaft 501 and the Y-axis support shaft 502, to make the dispensing nozzle 507 move horizontally (in X-Y directions).

The analyzer 500 of this embodiment operates as described above. Similarly to the first and the second embodiments, since the analyzer 500 allows discharging the material to be dispensed while moving the dispensing nozzle 507 and the stage 509 at the same time, as described above, it is capable of allowing the material being dispensed to be diffused into the material of the target immediately. In addition, since a mechanism for moving the illuminator 511 is not necessary in the analyzer 500, the analyzer 500 can be made compact.

The present disclosure is not limited to each of the foregoing embodiments but can be modified within the scope without departing from the gist of the present disclosure.

In each of the foregoing embodiments, it has been explained that the material to be dispensed is discharged in the state where the dispensing nozzle and the stage are moving in relative circular motion around the vertical direction (Z-direction) as the rotation axis. However, the relative movement between the dispensing nozzle and the stage is not limited to this, and may be a horizontal movement such as elliptical, rectangular, and linear motions. Circular motion is suitable because it restrains generation of mechanical vibrations. In addition, this relative movement may be a combination of a horizontal motion and a vertical motion as well. Further, the material to be dispensed may not necessarily be discharged simultaneously with the relative movement. It may be configured to allow the relative movement to start immediately after the material is discharged.

### Example

Examples of the present disclosure will be described. The following experiment was conducted to check the effectiveness of a dispensing method according to the present disclosure.

As laboratory equipment, well plate: 24 well bio-coated plate (collagen I), pipet (from Gilson, Inc.), reagent: DMSO (dimethyl sulfoxide), sample: myocardial pulsating cell (iCell cardiomyocyte (from Cellular Dynamics International, Inc.)) and imaging apparatus: C-lab live cell imaging system were employed.

The well plate on which the myocardial pulsating cells (iCell) were seeded was placed on the imaging apparatus, and it was maintained in an environment of 37° C. with 5-7% CO₂. The volume of culture medium in each well of the well plate was 500 μm. A video image of the myocardial pulsation (0 minutes after addition) was taken by the imaging apparatus.

A tip of the pipet was brought into contact with the culture medium inside the well, and 2.5 μl of DMSO was dispensed into the well in the following manner. “0 Hz”: The position of the pipet was fixed at the center of the well, and dispensing was performed at the speed of 2.5 μl/s. “1 Hz”: While the pipet was rotated at 1 Hz around the center of the well so as to draw a circle (as in FIG. 3), the dispensing was performed at the speed of 2.5 μl/s. “2 Hz”: While the pipet was rotated at 2 Hz around the center of the well so as to draw a circle (as in FIG. 3), the dispensing was performed at the speed of 1.25 μl/s. Incidentally, 2.5 μl, which was the added amount of DMSO, was 0.5% with respect to the total amount of the culture medium, while normally 0.1% or less would be the allowable percentage which does not affect the cells.

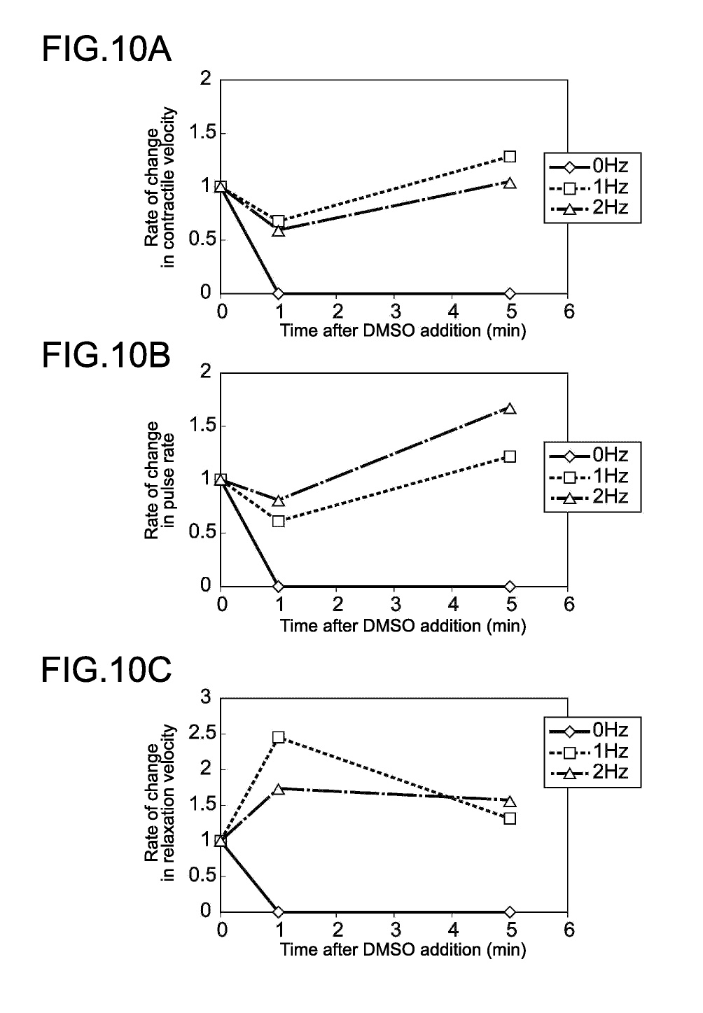

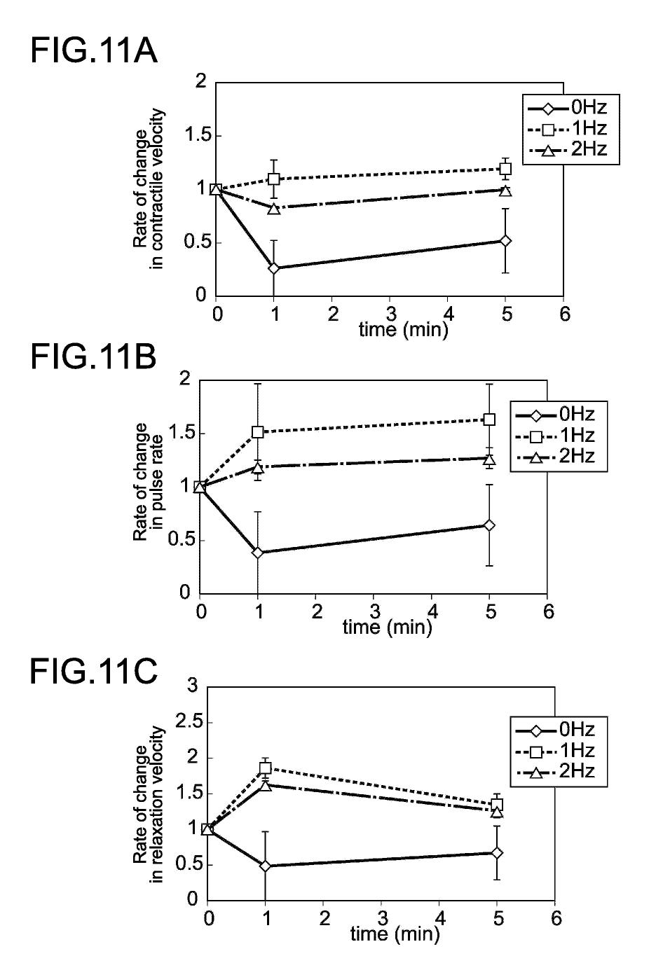

A video image of the myocardial pulsation in each well in which DMSO was added by the corresponding rotational speed was taken, after 1 minute and 5 minutes after addition of DMSO. The imaged regions were the center part and the edge part of the well. The video images taken were analyzed by CS Analyzer, and the pulse rate, contractile velocity, and relaxation velocity of the cardiomyocytes in the respective video images were compared with each other. FIGS. 10A to 10C and 11A to 11C are graphs showing the result of analysis.

FIGS. 10A to 10C are the result of analysis on the cardiomyocytes at the center of the well (the point where DMSO was added). FIG. 10A shows the rate of change in contractile velocity, FIG. 10B shows the rate of change in pulse rate, and FIG. 10C shows the rate of change in relaxation velocity. In every graph, a larger deviation from the value before addition of DMSO (“0 minutes after addition”) indicates the greater effect by DMSO.

In all of FIGS. 10A to 10C, when the pipet was not rotated (0 Hz), the rate of change which was measured 1 minute after the addition was 0. It showed that the addition of DMSO had an acute effect on the cardiomyocytes where DMSO was added. On the other hand, when the pipet was rotated (1 Hz, 2 Hz), the addition had a slight effect on the cardiomyocytes 1 minute after the addition, but the effect was lowered with the lapse of time. This means that the added DMSO was immediately diffused from the point of addition thereof, by rotation of the pipet. Further, the higher the rotational speed is (2 Hz), the lower the effect by the DMSO would be, which means that the diffusion of DMSO was even more accelerated.

FIGS. 11A to 11C are the result of analysis on the cardiomyocytes at the center of the well (away from the point where DMSO was added). FIG. 11A shows the rate of change in contractile velocity, FIG. 11B shows the rate of change in pulse rate, and FIG. 11C shows the rate of change in relaxation velocity. In every graph, a larger deviation from the value before addition of DMSO (“0 minutes after addition”) indicates the greater effect by DMSO.

In all of FIGS. 11A to 11C, when the pipet was not rotated (0 Hz), there was a large variation of values. This can be due to that the arrival of DMSO is dependent on the diffusion rate. On the other hand, when the pipet was rotated (1 Hz, 2 Hz), the variation of values was smaller as compared to the case where the pipet was not rotated. This means that DMSO was added, by the rotation, in uniform concentration throughout the cells. Further, the higher the rotational speed is (2 Hz), the smaller the variation would be, which means that the diffusion of DMSO was accelerated by the rotation.

Thus, as described above, the experiments have revealed that the dispensing method according to the present disclosure which has been described in the embodiments above, that is, the method of performing dispensing while changing relative position between the dispensing nozzle and the stage, can accelerate the diffusion of the dispensed material into the material of the target; and that the effect may be greater when the rotational speed is higher.

The present disclosure may employ the following configurations.

(1) A dispensing apparatus including:

a dispensing unit configured to support a dispensing nozzle, provide the dispensing nozzle with a material to be dispensed, and allow the dispensing nozzle to discharge the material; and

a drive mechanism configured to change relative position between a stage and the dispensing nozzle in a second direction and a third direction,
the second direction being a horizontal direction when a first direction is substantially vertical direction,
the third direction being substantially perpendicular to the first direction and to the second direction.

(2) The dispensing apparatus according to (1), further including:

a control unit configured to control the dispensing unit and the drive mechanism, to change the relative position between the stage and the dispensing nozzle in the second direction and the third direction while allowing the dispensing nozzle to discharge the material.

(3) The dispensing apparatus according to (1) or (2), in which

the control unit is configured to control the drive mechanism so that the dispensing nozzle and the stage are made to move in relative circular motion around the first direction as the rotation axis.

(4) The dispensing apparatus according to any one of (1) to (3), in which

the drive mechanism includes a first support shaft which has its axis along the first direction, a second support shaft which has its axis along the second direction, and a third support shaft which has its axis along the third direction,
the third support shaft being configured to drive the second support shaft in the third direction,
the second support shaft being configured to drive the first support shaft in the second direction, and
the first support shaft being configured to drive the dispensing unit in the first direction.

(5) The dispensing apparatus according to any one of (1) to (4), in which

the drive mechanism includes a first support shaft which has its axis along the first direction, a second support shaft which has its axis along the second direction, and a third support shaft which has its axis along the third direction,
the third support shaft being configured to drive the second support shaft in the third direction,
the second support shaft being configured to drive the stage in the second direction, and
the first support shaft being configured to drive the dispensing unit in the first direction.

(6) The dispensing apparatus according to any one of (1) to (5), in which

the drive mechanism includes a first support shaft which has its axis along the first direction, a second support shaft which has its axis along the second direction, and a third support shaft which has its axis along the third direction,
the third support shaft being configured to drive the first support shaft in the third direction,
the second support shaft being configured to drive the stage in the second direction, and
the first support shaft being configured to drive the dispensing unit in the first direction.

(7) The dispensing apparatus according to any one of (1) to (6), further including:

a liquid surface sensing unit configured to detect a liquid surface of a liquid contained in a container that is placed on the stage;

the control unit being further configured to regulate the relative position between the stage and the dispensing nozzle in the first direction, based on the result of detection by the liquid surface sensing unit.

(8) An analyzer including:

a dispensing unit configured to support a dispensing nozzle, provide the dispensing nozzle with a material to be dispensed, and allow the dispensing nozzle to discharge the material;

a drive mechanism configured to change relative position between a stage and the dispensing nozzle in a second direction and a third direction,
the second direction being a horizontal direction when a first direction is substantially vertical direction,
the third direction being substantially perpendicular to the first direction and to the second direction; and

an analyzing unit configured to analyze an object of analysis that is placed on the stage.

(9) The analyzer according to (8), further including:

an illuminator configured to illuminate the object of analysis with illumination light;

the drive mechanism further including a first support shaft which has its axis along the first direction, a second support shaft which has its axis along the second direction, and a third support shaft which has its axis along the third direction,
the third support shaft being configured to drive the first support shaft and the illuminator in the third direction,
the second support shaft being configured to drive the stage in the second direction, and
the first support shaft being configured to drive the dispensing unit in the first direction.

(10) The analyzer according to (8) or (9), further including:

an illuminator configured to illuminate the object of analysis with illumination light;

the drive mechanism further including a first support shaft which has its axis along the first direction, a second support shaft which has its axis along the second direction, and a third support shaft which has its axis along the third direction,
the third support shaft being configured to drive the first support shaft in the third direction,
the second support shaft being configured to drive the stage in the second direction, and
the first support shaft being configured to drive the dispensing unit in the first direction,

the analyzer further including
a tilt mechanism supported by the first support shaft and configured to tilt the dispensing unit with respect to the first direction.

(11) A method for controlling a dispensing apparatus, the method including:

supporting a dispensing nozzle,

providing the dispensing nozzle with a material to be dispensed, and

allowing the dispensing nozzle to discharge the material,
by a dispensing unit; and

changing relative position between a stage and the dispensing nozzle, by a drive mechanism, in a second direction and a third direction,
the second direction being a horizontal direction when a first direction is substantially vertical direction,
the third direction being substantially perpendicular to the first direction and to the second direction.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A dispensing apparatus comprising:
a dispensing unit configured to support a dispensing nozzle, provide the dispensing nozzle with a material to be dispensed, and allow the dispensing nozzle to discharge the material; and
a drive mechanism configured to change relative position between a stage and the dispensing nozzle in a second direction and a third direction,
the second direction being a horizontal direction when a first direction is substantially vertical direction,
the third direction being substantially perpendicular to the first direction and to the second direction.

2. The dispensing apparatus according to claim 1, further comprising:
a control unit configured to control the dispensing unit and the drive mechanism, to change the relative position between the stage and the dispensing nozzle in the second direction and the third direction while allowing the dispensing nozzle to discharge the material.

3. The dispensing apparatus according to claim 2, wherein
the control unit is configured to control the drive mechanism so that the dispensing nozzle and the stage are made to move in relative circular motion around the first direction as the rotation axis.

4. The dispensing apparatus according to claim 1, wherein
the drive mechanism includes a first support shaft which has its axis along the first direction, a second support shaft which has its axis along the second direction, and a third support shaft which has its axis along the third direction,
the third support shaft being configured to drive the second support shaft in the third direction,
the second support shaft being configured to drive the first support shaft in the second direction, and
the first support shaft being configured to drive the dispensing unit in the first direction.

5. The dispensing apparatus according to claim 1, wherein
the drive mechanism includes a first support shaft which has its axis along the first direction, a second support shaft which has its axis along the second direction, and a third support shaft which has its axis along the third direction,
the third support shaft being configured to drive the second support shaft in the third direction,
the second support shaft being configured to drive the stage in the second direction, and
the first support shaft being configured to drive the dispensing unit in the first direction.

6. The dispensing apparatus according to claim 1, wherein
the drive mechanism includes a first support shaft which has its axis along the first direction, a second support shaft which has its axis along the second direction, and a third support shaft which has its axis along the third direction,
the third support shaft being configured to drive the first support shaft in the third direction,
the second support shaft being configured to drive the stage in the second direction, and
the first support shaft being configured to drive the dispensing unit in the first direction.

7. The dispensing apparatus according to claim 2, further comprising:
a liquid surface sensing unit configured to detect a liquid surface of a liquid contained in a container that is placed on the stage;
the control unit being further configured to regulate the relative position between the stage and the dispensing nozzle in the first direction, based on the result of detection by the liquid surface sensing unit.

8. An analyzer comprising:
a dispensing unit configured to support a dispensing nozzle, provide the dispensing nozzle with a material to be dispensed, and allow the dispensing nozzle to discharge the material;
a drive mechanism configured to change relative position between a stage and the dispensing nozzle in a second direction and a third direction,
the second direction being a horizontal direction when a first direction is substantially vertical direction,
the third direction being substantially perpendicular to the first direction and to the second direction; and
an analyzing unit configured to analyze an object of analysis that is placed on the stage.

9. The analyzer according to claim 8, further comprising:
an illuminator configured to illuminate the object of analysis with illumination light;
the drive mechanism further including a first support shaft which has its axis along the first direction, a second support shaft which has its axis along the second direction, and a third support shaft which has its axis along the third direction,
the third support shaft being configured to drive the first support shaft and the illuminator in the third direction,
the second support shaft being configured to drive the stage in the second direction, and
the first support shaft being configured to drive the dispensing unit in the first direction.

10. The analyzer according to claim 8, further comprising:
an illuminator configured to illuminate the object of analysis with illumination light;
the drive mechanism further including a first support shaft which has its axis along the first direction, a second support shaft which has its axis along the second direction, and a third support shaft which has its axis along the third direction,
the third support shaft being configured to drive the first support shaft in the third direction,
the second support shaft being configured to drive the stage in the second direction, and
the first support shaft being configured to drive the dispensing unit in the first direction,
the analyzer further including
a tilt mechanism supported by the first support shaft and configured to tilt the dispensing unit with respect to the first direction.

11. A method for controlling a dispensing apparatus, the method comprising:
supporting a dispensing nozzle,
providing the dispensing nozzle with a material to be dispensed, and
allowing the dispensing nozzle to discharge the material,
by a dispensing unit; and
changing relative position between a stage and the dispensing nozzle, by a drive mechanism, in a second direction and a third direction,
the second direction being a horizontal direction when a first direction is substantially vertical direction,
the third direction being substantially perpendicular to the first direction and to the second direction.
